(19) United States
(12) Patent Application Publication
(10) Pub. No.: US 2003/0115486 A1
(43) Pub. Date: Jun. 19, 2003

(54) Intrusion detection method using adaptive rule estimation in network-based instrusion detection system

(76) Inventors: Byeong Cheol Choi, Taejon (KR); Dong Il Seo, Taejon (KR); Sung Won Sohn, Taejon (KR); Chee Hang Park, Taejon (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 10/273,140

(22) Filed: Oct. 18, 2002

(30) Foreign Application Priority Data
Dec. 14, 2001 (KR) 2001-79179

(51) Int. Cl. G06F 11/30

(52) U.S. Cl. 713/201

(57) ABSTRACT

An intrusion detection method by adaptive rule estimation in a network-based intrusion detection system (NDS) is disclosed. The method includes collecting a packet on a network and searching for an original rule most similar to the collected packet from a rule database in which a rule for intrusion detection is stored, and judging whether a hacker intrudes by estimating a changed position of the collected packet from the original rule. Accordingly, it is possible to prevent an indirect attack of a hacker using a packet whose number of bits is changed due to deletion/insertion of characters from/into the packet.

### BACKGROUND OF THE INVENTION

1. Field of the Invention

The present invention relates to an intrusion detection system for detecting a hacker who intrudes on a computer network, and more particularly, to an intrusion detection method using adaptive rule estimation in a network-based intrusion detection system NIDS).

2. Background of the Related Art

As is well known, a network-based intrusion detection system (NIDS) is a system for detecting a hacker who intrudes on a computer network. Whether a hacker intrudes is judged by executing a rule-based pattern matching method, which is most widely used for misuse detection, for packets collected on a network on the basis of a predetermined rule stored in a rule database.

Referring to FIG. 1, a conventional NIDS copes with the intrusion in a manner that a packet collector 10 collects packets on a network, a packet filter 20 filters the collected packets to be suitable for an intrusion judgment method of a system, and an intrusion judgment section 40 compares a predetermined rule of a rule database 30, in which a rule for intrusion detection is stored, with the filtered packets by a one-to-one pattern matching method, judges whether a hacker intrudes, and reports a warning message to a system manager.

However, the conventional NIDS having the above structure judges whether a hacker intrudes by the intrusion judgment section 40 comparing the packets collected by the one-to-one pattern matching method with a specified rule stored in the rule database 30. Therefore, when a packet based on a rule that is not stored in the rule database 30 is collected, it is almost impossible to detect the intrusion of the hacker.

For example, when a hacker launches an indirect attack of changing the form of a character packet by deleting the character of a specified bit from or inserting the character of a specified bit into an 8 bit character packet, it is not possible to detect the intrusion of the hacker by the one-to-one pattern matching method.

### SUMMARY OF THE INVENTION

Accordingly, the present invention is directed to an intrusion detection method using adaptive rule estimation in a NIDS, which substantially obviates one or more problems due to limitations and disadvantages of the related art.

It is an object of the present invention to provide an intrusion detection method by adaptive rule estimation in a NIDS that judges whether a hacker intrudes by an intrusion judgment section applying a specified rule stored in a rule database to an adaptive rule estimation method when a packet whose number of bits is changed due to deletion/insertion of a character from/into the packet is collected on a network.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

In order to achieve the above object, there is provided an intrusion detection method by adaptive rule estimation in a NIDS, comprising the steps of collecting a packet on a network and searching for an original rule most similar to the collected packet from a rule database in which a rule for intrusion detection is stored, and judging whether a hacker intrudes by estimating a changed position of the collected packet from the original rule.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating a general network-based intrusion detection system (NIDS).

FIG. 2 is a flowchart illustrating an intrusion detection method by adaptive rule estimation in a NIDS according to the present invention.

FIG. 3 is a view illustrating a character table for intrusion detection according to the intrusion detection method by adaptive rule estimation in the NIDS according to the present invention.

FIGS. 4 and 5 are views illustrating a sample simulation result according to the intrusion detection method by adaptive rule estimation of the NIDS according to the present invention.

FIG. 6 is a view illustrating a performance of the intrusion detection method by adaptive rule estimation in the NIDS according to the present invention.

### DETAILED DESCRIPTION OF THE PREFERRED EMBODIMENT

An intrusion detection method by adaptive rule estimation of a network-based intrusion detection system (NIDS) according to the preferred embodiment of the present invention will now be explained in detail with reference to the accompanying drawings.

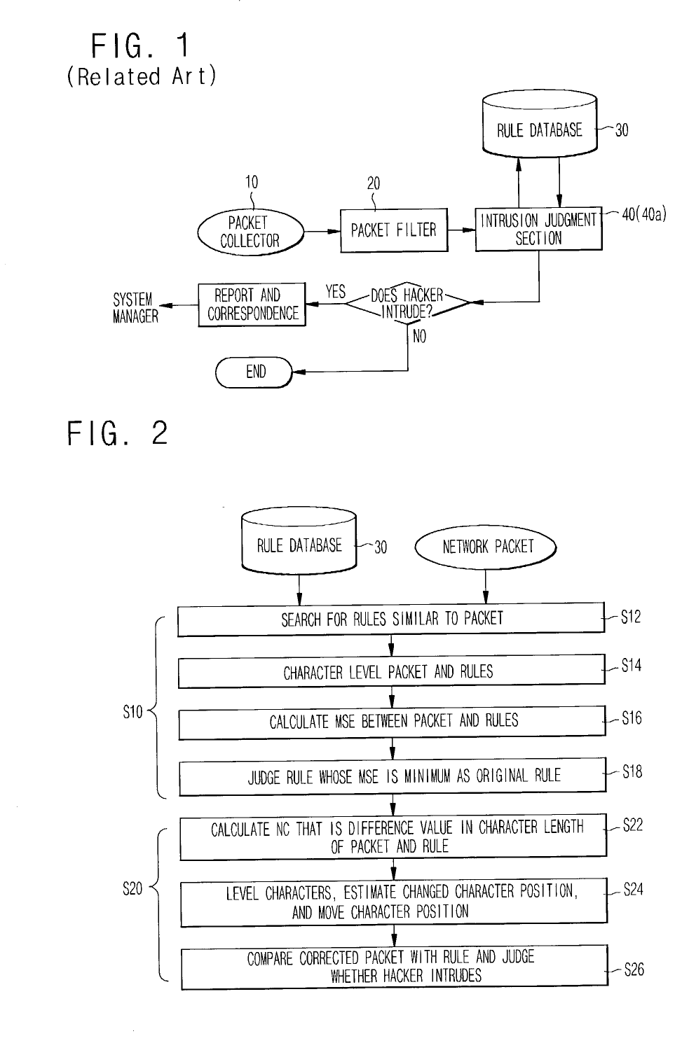

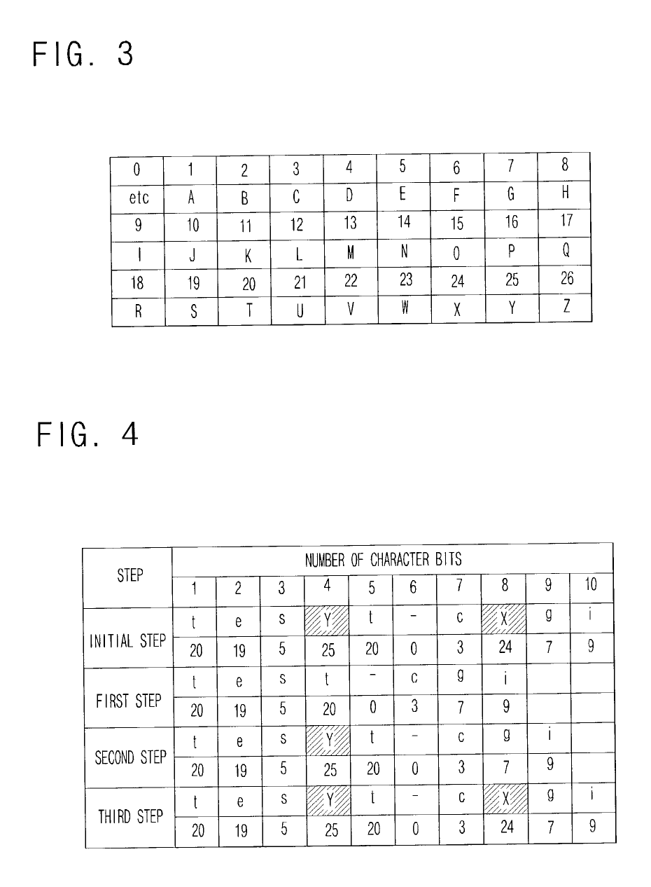

Referring to FIG. 1, a packet collector 10 of a NIDS according to the present invention collects packets on a network.

A packet filter 20 filters the collected packets to be suitable for an intrusion judgment method of a system.

A rule database 30 stores a rule for intrusion detection.

An intrusion judgment section 40a compares a predetermined rule stored in the rule database 30 with a packet filtered by applying adaptive rule estimation, judges whether a hacker intrudes, and reports a warning message to a system manager to thus cope with intrusion.

The NIDS according to the present invention having the above structure operates by a method illustrated in FIG. 2.

Referring to FIG. 2, after packets are collected on a network by the packet collector 10 and are filtered by the packet filter 20, the collected packets are applied to the intrusion judgment section 40a. Then, the intrusion judgment section 40a searches for the original rule that is most similar to the collected packets from the rule database 30 in which a rule for intrusion detection is stored (step S10).

At this time, the intrusion judgment section 40a searches for a plurality of rules similar to the collected packets from the rule database (step S12), and performs a character leveling work for the packets and the rules using a predetermined character table additionally included in order to detect the intrusion as shown in FIG. 4 (step S14).

In the character table shown in FIG. 4, the numbers written down above the characters to correspond to the characters illustrate the level values of the corresponding characters.

When the character leveling work for the packets and the rules is completed, a mean square error (MSE) among the packets and the rules is calculated (step S16). The rule whose MSE is minimum is judged to be the original rule most similar to the collected packet.

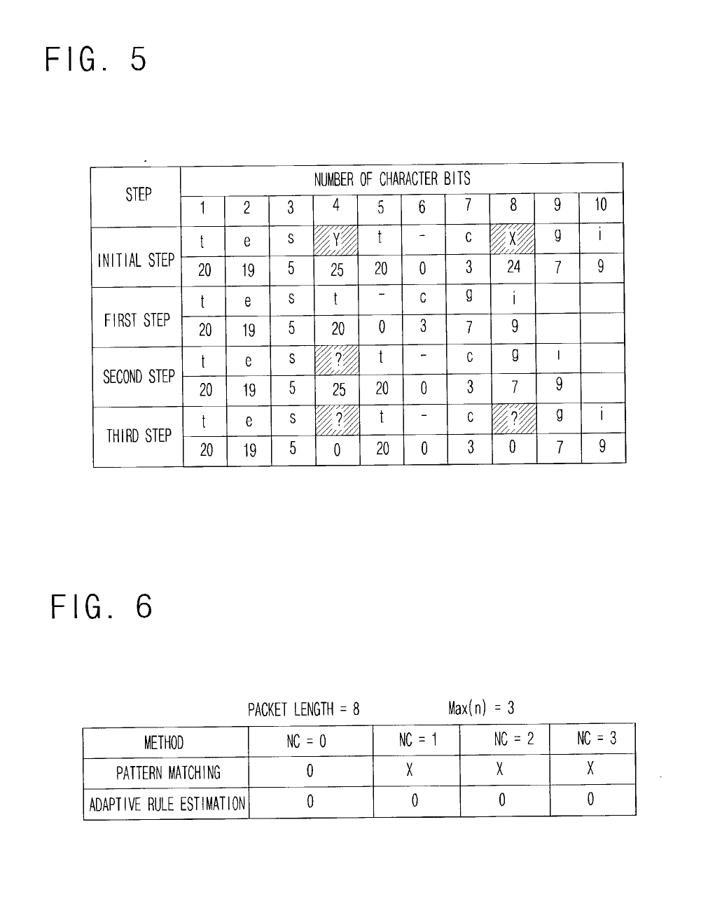

Referring to FIGS. 5 and 6, in the case where the collected packet is a 10-bit packet referred to as tesYt-cXgi, and the 10-bit packet is character-leveled using the character table of FIG. 4, the respective character bits in the 10 bit packet referred to as tesYt-cXgi have the level values of 20, 19, 5, 25, 20, 0, 3, 24, 7, and 9 (the initial steps of FIGS. 5 and 6).

According to the present invention, the original rule detected among the rules similar to the 10-bit packet referred to as tesYt-cXgi is a 8-bit packet. When the original rule is character-leveled, in the 8-bit packet referred to as test-cgi, the respective character bits have the level values of 20, 19, 5, 20, 0, 3, 7, and 9 (the first steps of FIGS. 5 and 6)

The MSE between the 10-bit packet referred to as tesYt-cXgi and the original rule is obtained by adding level values corresponding to 9 and 10 bits to 8 level values of the original rule formed of the 8-bit packet referred to as test-cgi to thus set a norm count (NC) to ‘0’ and, squaring 10 values obtained by performing subtraction between 10 level values from 1 bit to 10 bits of the 10-bit packet referred to as tesYt-cXgi and the 10 values so as to one-to-one correspond each other, and adding the squared values to each other.

When the original rule for the collected packets is extracted, the intrusion judgment section 40a estimates the changed position of the collected packet from the original rule and judges whether a hacker intrudes (step S20).

The intrusion judgment section 40a calculates a NC that is a difference value in character length between the packet and the original rule, that is, a difference value in the number of character bits.

For example, as shown in FIGS. 5 and 6, when the original rule for the 10-bit packet referred to as tesYt-cXgi is the 8-bit packet test-cgi, the NC is 2. That the NC is 2 means that the collected packet is a packet into which 2 characters are inserted or from which 2 characters are deleted, when the collected packet is compared with the original rule.

When a predetermined NC is calculated, the intrusion judgment section 40a performs a character leveling work for the collected packet in the same manner as above, in which the character leveling work is performed at the step S10 of searching for the original rule, estimates the changed position from the original rule, and changes the character position of the packet (step S24).

For example, when the 10-bit packet referred to as tesYt-cXgi is character leveled, the respective character bits have the level values of 20, 19, 5, 25, 20, 0, 3, 24, 7, and 9 (the initial steps of FIGS. 5 and 6) in the 10-bit packet referred to as tesYt-cXgi.

When the level value of the 10-bit packet is compared with the level value of the original rule formed of the 8-bit packet referred to as test-cgi as illustrated at the second and third steps of FIGS. 5 and 6, an initially collected packet is detected by estimating that 4th and 8th bits of the 10-bit packet are changed into Y or an arbitrary character different from the characters corresponding to the 4th and 8th bits of the original rule and by sequentially moving the character position of the original rule.

When the initially collected packet is detected by moving the character position of the original rule, the intrusion judgment section 40a compares the packet corrected by moving the character position with the original rule, judges whether a hacker intrude, and reports a warning message to a system manager so that the system manager can correspond to intrusion of a hacker (step S26).

Referring to FIG. 6, when the NC that is a difference value in character length between the collected packet and the original rule is ‘0’, that is, the packet is not changed, the intrusion of the hacker can be detected by an intrusion detection method by adaptive rule estimation according to the present invention and the conventional intrusion detection method, to which the rule-based one-to-one pattern matching is applied and which is most widely used for misuse detection.

However, in the case where the NC is more than ‘1’, that is, in case that a packet is changed because one or more characters are inserted into or deleted from the packet, the intrusion of a hacker can be detected only by the intrusion detection method by adaptive rule estimation.

In the intrusion detection method by the adaptive rule estimation of the NIDS according to the present invention, when a packet whose number of bits is changed due to deletion/insertion of characters from/into the packet is collected on a network, whether a hacker intrudes is judged by the intrusion judgment section that applies a specified rule stored in a rule database to an adaptive rule estimation method. Accordingly, it is possible to prevent the indirect attack of the hacker using a packet whose number of bits is changed due to deletion/insertion of characters from/into the packet.

While the intrusion detection method by the adaptive rule estimation of the NIDS according to the present invention has been described and illustrated herein with reference to the preferred embodiment thereof, it will be understood by those skilled in the art that various changes and modifications may be made to the invention without departing from the spirit and scope of the invention, which is defined in the appended claims.

What is claimed is:

1. An intrusion detection method by adaptive rule estimation in a network-based intrusion detection system (NIDS), comprising the steps of:
collecting a packet on a network, and searching for an original rule most similar to the collected packet from a rule database in which a rule for intrusion detection is stored; and
judging whether a hacker intrudes by estimating a changed position of the collected packet from the original rule.

2. The intrusion detection method of claim 1, wherein the step of collecting the packet and searching for the original rule comprises the steps of:
searching for rules similar to the packet collected on the network from the rule database;
performing a character leveling work for the packet and the rules using a character table;
calculating a mean square error (MSE) between the packet and the rules; and
judging a rule whose MSE is minimum as an original rule the most similar to the packet.

3. The intrusion detection method of claim 1, wherein the judging step comprises the steps of:
calculating a norm count (NC) that is a difference value in character length between the packet and the original rule;
performing a character leveling work for the packet, estimating a changed position from the original rule, and moving the character position of the packet; and
comparing the packet corrected due to the movement of the character position with the original rule, to thus judge whether a hacker intrudes.
